(19) United States
(12) Patent Application Publication
(10) Pub. No.: US 2008/0141263 A1
(43) Pub. Date: Jun. 12, 2008

(54) EMBEDDED AGENT FRAMEWORK AND METHOD OF PROVIDING UBIQUITOUS SERVICES USING THE SAME

(76) Inventors: Moon Sub SONG, Daejeon (KR); Jung Eun CHA, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/952,162

(22) Filed: Dec. 7, 2007

(30) Foreign Application Priority Data
Dec. 8, 2006 (KR) 10-2006-0124208

(51) Int. Cl. G06F 9/50

(52) U.S. Cl. 718/104

(57) ABSTRACT

Provided are an embedded agent framework for providing a user with complex and convenient services required in a ubiquitous environment through intelligent cooperation between various embedded systems and a method of providing services using the same.

An embedded agent framework installed in an embedded system includes: a plurality of service execution agents executing services requested by the embedded system; a system interface agent converting a service request generated by the embedded system into a format understandable by the embedded agent framework (EAF); a service control agent receiving the converted service request from the system interface agent, analyzing the requested services, and requesting a service execution agent providing the analyzed services to execute the services; and an EAF interface agent for communicating with an external embedded agent framework, wherein, when the analyzed services are services provided by an external service execution agent of the external embedded agent framework, the external service execution agent is requested to execute the services through the EAF interface agent.

### CROSS-REFERENCE TO RELATED APPLICATION

This application claims priority to and the benefit of Korean Patent Application No. 2006-124208, filed Dec. 8, 2006, the disclosure of which is incorporated herein by reference in its entirety.

### BACKGROUND

1. Field of the Invention

The present invention relates to an embedded agent framework for providing a user with complex and convenient services required in a ubiquitous environment through intelligent cooperation between various embedded systems and a method of providing services using the same.

The present invention has been produced from the work supported by the IT R&D program of MIC (Ministry of Information and Communication)/IITA (Institute for Information Technology Advancement) [2005-S-022-02, Embedded Software-based SmarTown Solotion] in Korea.

2. Discussion of Related Art

Agent framework technology is technology in which application agents are developed according to an agent specification based on a framework (middleware), rather than simply developed to be dependant on a system, to thereby facilitate the management and cooperation of the agents. Further, agent framework technology is used to take advantage of agents having high-level interoperability between different agent systems in a conventional enterprise system or desk top system level. Research into agents that have emphasized intelligence is actively progressing to meet users' demand for development of hardware performance and high quality service.

In particular, development of sensor network technology results in more easily obtainable context information with respect to a user environment, and this leads to an increased demand for an embedded system taking advantage of the obtained results. In addition, as quality of life increases with an increased demand for agent services such as a robot that can act on behalf of a user, research into artificial intelligence is progressing again.

In addition, in an automobile field, costs for development of embedded software (as opposed to hardware) controlling parts of an automobile have increased, and agent technology is introduced for the sake of cooperation between the embedded software systems, and provision of high quality services to users. Also, the agent technology is developed to provide safety, security, and convenience to the users at home or in a building.

In the ubiquitous environment, automation a user cannot easily recognize is required, and data communication and a control thereof are organically performed based on the user to thereby provide the services. To perform the services, the obtained information should be analyzed, and an environment change depending on the circumstances is provided, or information should be provided to the user.

However, since required agents are temporarily developed according to an application in each embedded system, it is difficult to manage agents in the same system. In addition, since the demand for high quality services through cooperation between the embedded agents is increased, a cooperation mechanism based on the specification of the agent is required for cooperation between the agents and the embedded agent framework technology capable of providing the services.

### SUMMARY OF THE INVENTION

The present invention is directed to an embedded agent framework for providing a user with complex and convenient services required in a ubiquitous environment through intelligent cooperation between various embedded systems, and a method of providing services using the same.

One aspect of the present invention provides an embedded agent framework installed in an embedded system, the embedded agent framework including: a plurality of service execution agents executing services requested by the embedded system; a system interface agent converting a service request generated by the embedded system into a format understandable by the embedded agent framework (EAF); a service control agent receiving the converted service request from the system interface agent, analyzing the requested services, and requesting a service execution agent providing the analyzed services to execute the services; and an EAF interface agent for communicating with an external embedded agent framework, wherein, when the analyzed services are services provided by an external service execution agent of the external embedded agent framework, the external service execution agent is requested to execute the services through the EAF interface agent.

The embedded agent framework may further include an internal management database (DB) for storing information on service execution agents existing inside the embedded framework; an external management DB for storing information on service execution agents existing outside the embedded framework; and an agent management agent registering the information on the service execution agents existing inside and outside the embedded framework in the internal and external management DBs, respectively, and changing and deleting the registered information.

Another aspect of the present invention provides a method of providing services using an embedded agent framework including a service execution agent, a system interface agent, a service control agent, and an EAF interface agent including the steps of: receiving, by the system interface agent, a service request, converting the received request into a selected format, and transmitting the service request in the selected format to the service control agent; searching for, by the service control agent, a service execution agent providing the requested services; and requesting the searched service execution agent to execute the services, wherein, when the searched service execution agent is outside the embedded agent framework, the service execution agent is requested to execute the services through the EAF interface agent.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a configuration of an embedded agent framework (EAF) implemented in an embedded system according to an exemplary embodiment of the present invention;

FIG. 2 illustrates a configuration of a service execution agent according to an exemplary embodiment of the present invention;

FIG. 3 is a flowchart illustrating generation and management processes of a service execution agent according to an exemplary embodiment of the present invention; and

FIG. 4 is a flowchart illustrating a process of providing ubiquitous services to a user using an embedded agent framework according to an exemplary embodiment of the present invention.

### DETAILED DESCRIPTION OF EMBODIMENTS

The present invention will now be described more fully hereinafter with reference to the accompanying drawings, in which exemplary embodiments of the invention are shown. This invention may, however, be embodied in different forms and should not be construed as limited to the exemplary embodiments set forth herein.

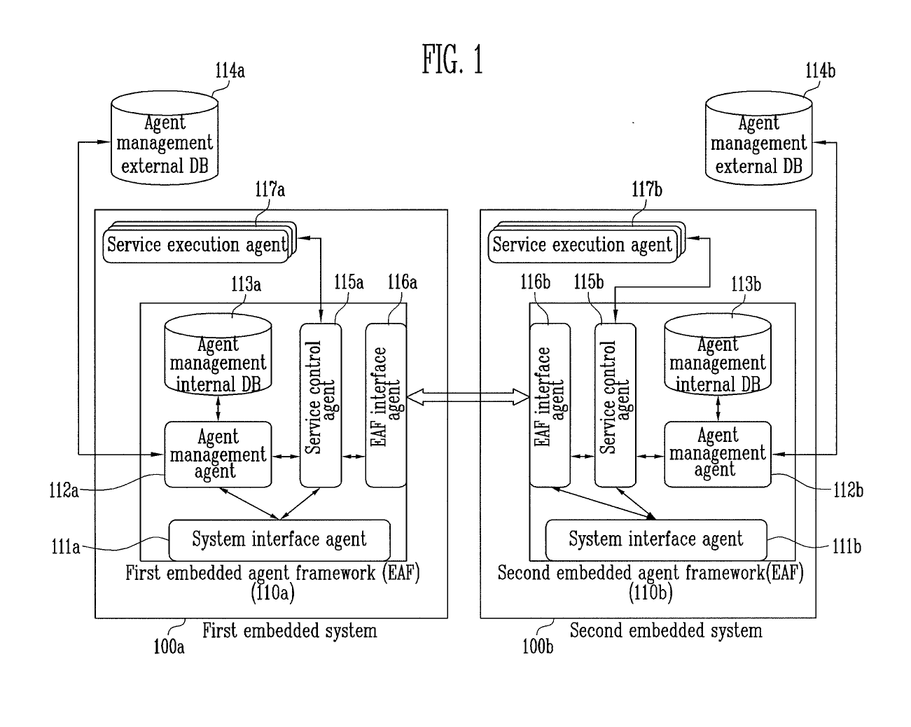

FIG. 1 illustrates a configuration of an embedded agent framework (EAF) implemented in an embedded system according to an exemplary embodiment of the present invention. As illustrated, a first embedded agent framework 110a and a second embedded agent framework 110b are respectively installed in first and second embedded systems. While only the first and second embedded agent frameworks 110a and 110b installed in the first and second embedded systems are illustrated in FIG. 1 for the sake of simplicity, one of ordinary skill in the art have understood that a plurality of embedded agent frameworks may be substantially installed in different embedded systems. Since the first embedded agent framework 110a has substantially the same configuration as the second embedded agent framework 110b, descriptions will be made below based on the first embedded agent framework 110a.

The first embedded agent framework 110a is implemented in the first embedded system 100a, and includes a system interface agent 111a, an agent management agent 112a, an agent management internal database (DB) 113a, an agent management external DB 114a, a service control agent 115a, an EAF interface agent 116a, and a service execution agent 117a.

The system interface agent 111a is an agent that interfaces with the first embedded system 100a, and when a service request is automatically generated according to an environment change in the first embedded system 100a, or when a service request is received from a user, the system interface agent 111a converts the corresponding service request into a selected format, i.e., a format understandable by the embedded agent framework to thereby transmit to the service control agent 115a. For example, an agent language such as Knowledge Query and Manipulation Language (KQML) or a protocol that processes distributed object communication such as Object Request Broker (ORB) of Common Object Request Broker Architecture (CORBA) may be used as the format understandable by the embedded agent framework.

The service control agent 115a analyzes the service request received from the system interface agent 111a, and requests an internal or external service execution agent to execute the services. Specifically, the service control agent 115a determines whether the requested services are single services or composite services, and instructs the corresponding service execution agent to execute the services. The single services are services that can be individually provided by one service execution agent, and the composite services are services that can be provided by two or more service execution agents through cooperation between the same. The service control agent 115a instructs the agent management agent 112a to search for the corresponding service execution agent, and requests the external service execution agent to execute the services through the EAF interface agent 116a when the service execution agent is outside the system. The EAF interface agent 116a is an agent that performs communication to cooperate with the external second embedded agent framework 110b, and communicates with an EAF interface agent 116b of the second embedded agent framework 110b to thereby request the external service execution agent to execute the services. The agent management agent 112a registers information on the service execution agents 117a in the agent management internal DB 113a or in the agent management external DB 114a, deletes or changes the registered information, and searches for the corresponding service execution agent in the DBs 113a and 114a according to instructions of the service control agent 115a. When the service execution agent 117a is in the system, the agent is registered in the agent management internal DB 113a, and when the service execution agent 117a is outside the system, the agent is registered in the agent management external DB 114a. Items registered in the respective DBs include an agent unique identifier (UID), a uniform resource locator (URL) that is location information of an agent, an agent status, an agent type, a function, etc.

The service execution agent 117a is an embedded agent implemented in the embedded system to actually perform service operations. In order for service execution agents to operate in the embedded agent framework, a structure of the service execution agents should be implemented as a standard language, such as an agent specification language. For example, Mobile Agent Facilities (MAF) defined by an international de-facto standard group, OMG, MC COM+, SUN's Enterprise JavaBeans (EJB), CORBA Component Model (CCM) of Object Management Group (OMG), etc., may be implemented as the standard language. The services should be defined in one transaction unit. The service execution agent 117a is registered in the agent management internal and external DBs, and the registration is performed by the agent management agent.

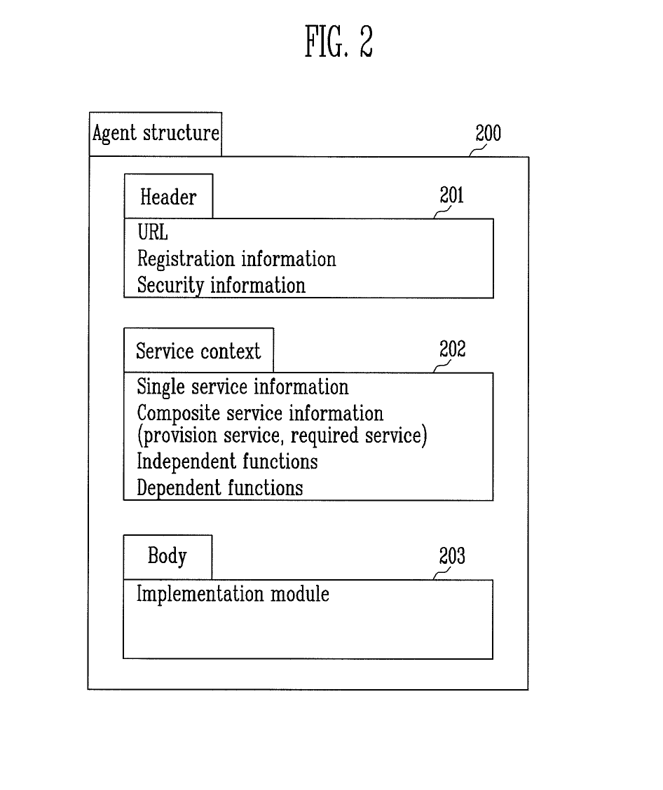

FIG. 2 illustrates a configuration of a service execution agent according to an exemplary embodiment of the present invention. As illustrated, a service execution agent 200 is generally divided into a header 201, a service context 202, and a body 203. The header 201 includes address information (e.g., URL) that is identification information of the corresponding agent 200, registration information (e.g., a name of the agent, a date of generation, and information on the agent version), and security information (e.g., (control) authority to request the execution of the services of the corresponding agent, possession authority, and activation/inactivation condition information).

The service context 202 includes single services and composite services (provision services and required services). The single services are services that can be individually provided by a service execution agent, and the composite services are services that can be provided by two or more service execution agents through cooperation between the same. The composite services include the provision service information to be provided to other agents by the corresponding agent, and the required information to be provided to the corresponding agent. Independent functions are functions demanded for the execution of the single services, and dependant functions are functions the corresponding agent is responsible for when the agent executes the composite services.

The body 203 includes an implementation module for operating the actual services the service execution agent is responsible for.

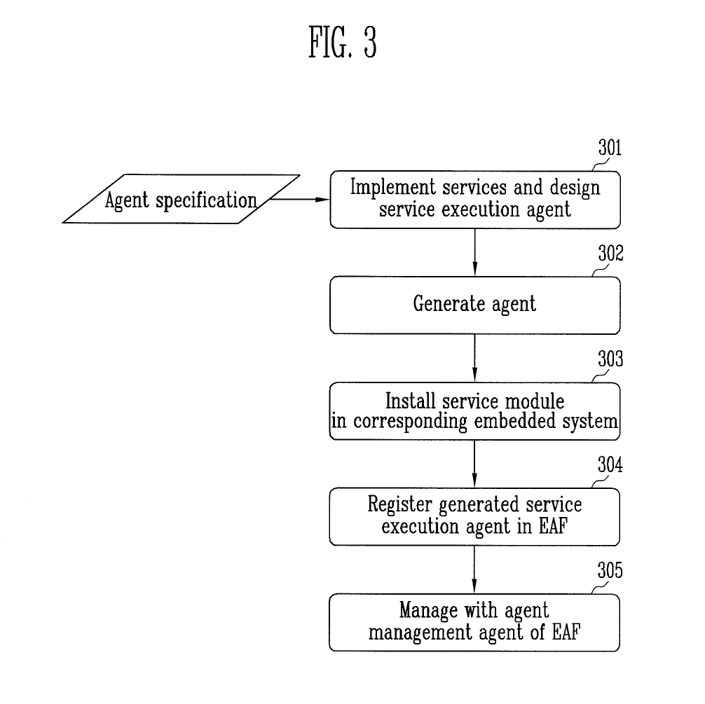

FIG. 3 is a flowchart illustrating generation and management processes of a service execution agent according to an exemplary embodiment of the present invention. First, a service execution agent is designed according to an agent specification and services to be executed by the agent are implemented (step 301), and the service execution agent is generated (step 302).

The generated service execution agent is installed in the corresponding embedded system (step 303), and the installed agent is registered in an EAF (step 304). The registration is performed by storing information on the service execution agent installed in an internal or external agent management DB by an agent management agent. The information on the registered service execution agent is managed by an agent management agent, and may be changed or deleted depending on the circumstances (step 305).

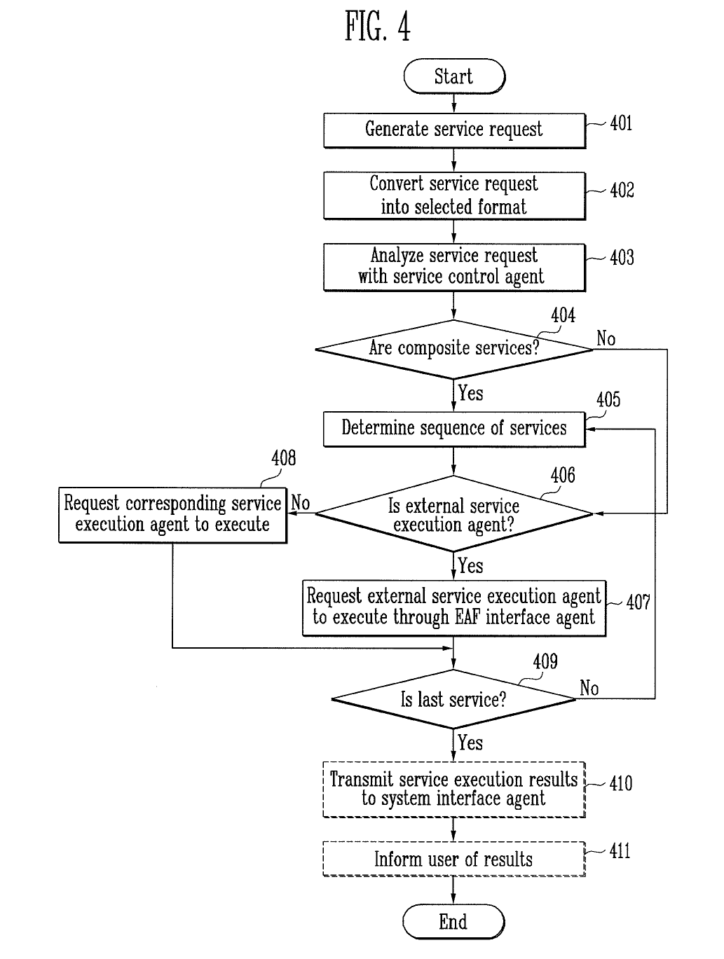

FIG. 4 is a flowchart illustrating a method of providing ubiquitous services to a user using an embedded agent framework according to an exemplary embodiment of the present invention.

When a service request is generated according to a status change, or a service request is received from a user in a ubiquitous environment (step 401), a system interface agent converts the service request into a selected format (i.e. a format understandable by an embedded agent framework), and transmits the converted service request to a service control agent (step 402).

The service control agent analyzes the service request (step 403), and determines whether the requested services are composite services or not (step 404). When the requested services are the composite services, a sequence of the services is determined, and a service execution agent providing the corresponding services is searched for according to the sequence (step 405).

Then, it is determined whether the corresponding service execution agent is a service execution agent outside the system or not (step 406). When the corresponding service execution agent is in the system, the agent is directly requested to execute the services (step 408), however, when the corresponding service execution agent is outside the system, the external service execution agent is requested to execute the services through an EAF interface agent.

It is determined whether there are further services to be provided (step 409), and when there are further services to be provided, the process returns to step 405, and repeats steps 406 to 409 until the last service is provided.

Additionally, service execution results are transmitted to a system interface agent depending on the circumstances (step 410) to thereby inform the user of the results (step 411). When the services are control-related services, only the execution of the services is performed, and the operation is terminated.

As described above, an embedded system controls service execution agents for providing intelligent services to a user in an embedded agent framework (middleware), so that various user services may be provided in a ubiquitous environment. Also, dynamically combined services are provided through cooperation with embedded agent frameworks installed in other embedded systems, so that convenient and continuous services may be provided to the user.

While the invention has been shown and described with reference to certain exemplary embodiments thereof, it will be understood by those skilled in the art that various changes in forms and details may be made therein without departing from the spirit and scope of the invention as defined by the appended claims.

What is claimed is:

1. An embedded agent framework installed in an embedded system, the embedded agent framework comprising:
a plurality of service execution agents executing services requested by the embedded system;
a system interface agent converting a service request generated by the embedded system into a format understandable by the embedded agent framework (EAF);
a service control agent receiving the converted service request from the system interface agent, analyzing the requested services, and requesting a service execution agent providing the analyzed services to execute the services; and
an EAF interface agent for communicating with an external embedded agent framework,
wherein, when the analyzed services are services provided by an external service execution agent of the external embedded agent framework, the external service execution agent is requested to execute the services through the EAF interface agent.

2. The embedded agent framework of claim 1, further comprising:
an internal management database (DB) for storing information on service execution agents existing inside the embedded framework;
an external management DB for storing information on service execution agents existing outside the embedded framework; and
an agent management agent registering the information on the service execution agents existing inside and outside the embedded framework in the internal and external management DBs, respectively, and changing and deleting the registered information.

3. The embedded agent framework of claim 2, wherein the service control agent searches for a service execution agent providing the analyzed services in the internal and external management DBs.

4. The embedded agent framework of claim 2, wherein the internal and external management DBs comprise an agent identifier, location information, an agent status, an agent type, and function information.

5. The embedded agent framework of claim 2, wherein the service execution agent comprises a header having identification information of the agent, a service context having service information, and a body having an implementation module that operates in order for the agent to provide the services.

6. The embedded agent framework of claim 2, wherein the service context comprises information on single services and composite services, the composite service information comprising provision service information to be provided to other service execution agents by the service execution agent, and required service information to be provided to the service execution agent.

7. A method of providing services using an embedded agent framework comprising a service execution agent, a system interface agent, a service control agent, and an EAF interface agent, the method comprising the steps of:
receiving, by the system interface agent, a service request, converting the received request into a selected format, and transmitting the service request in the selected format to the service control agent;
searching for, by the service control agent, a service execution agent providing the requested services; and
requesting the searched service execution agent to execute the services,
wherein, when the searched service execution agent is outside the embedded agent framework, the service execution agent is requested to execute the services through the EAF interface agent.

8. The method of claim 7, wherein when the requested services are composite services, a sequence of the services is determined, and a service execution agent providing the corresponding services is requested to execute the services based on the sequence of the services.

9. The method of claim 7, further comprising the step of transmitting the service execution results to the system interface agent to thereby inform a user of the results.
